(19) United States
(12) Patent Application Publication
(10) Pub. No.: US 2006/0272897 A1
(43) Pub. Date: Dec. 7, 2006

(54) Locking ladder

(76) Inventor: James Wylder, Aloha, OR (US)

Correspondence Address: James Wylder, 1240 SW 201st Avenue, Aloha, OR, 97006, US

(21) Appl. No.: 11/145,244

(22) Filed: Jun. 6, 2005

(51) Int. Cl. E06C 5/32

(52) U.S. Cl. 182/129

(57) ABSTRACT

A universal ladder locking mechanism for locking a ladder and other equipment to an immoveable object. Affixed to one side of the ladder frame is a lock housing in which the loop end of the cable is inserted into and locked via a lock receptacle and elongate arm mechanism. On the other side of the ladder frame is the metal housing that contains a spring loaded pulley system and the loop ended cable that will be wrapped around an immoveable object and secured back to the lock housing on the other side of the ladder frame. The elongate lock arm and lock receptacle on the lock housing prevent the cable from being released without the use of the universal key, thereby preventing theft of the secured equipment.

### FIELD OF INVENTION

The present invention relates generally to a locking ladder mechanism and, more particularly, is highly suitable for providing a universal ladder lock to secure ladders and/or various other equipment on construction job sites, as well as, to vehicles other any other immoveable object. This invention relates generally to an extension ladder that is both by residential and commercial contractors, as well as, homeowners. The focus of this document will be toward the residential and commercial building contractor useage for this device. This in no way limits the use of the device to this field, as stated in the appended claims. The Locking Ladder mechanism will be used to ensure that the contractor will no longer need to have cumbersome chains and separate pad locks, etc. to secure ladders at a job site. This device can be used to secure ladders to virtually any device by the wrapping of a cable.

### BACKGROUND OF INVENTION

Residential and Commercial contractors use ladders on a daily basis to perform their jobs. At the end of the day, all of the gear that is used on a job site must either be secured by chains and pad locks or removed from the site to prevent theft. The current method of using chains and pad locks does not provide a fool proof way of securing the equipment from theft. Typically, anyone with bolt cutters can cut the conventional chains that are used currently to secure equipment. This invention will eliminate the need for additional pieces of equipment for the contractor to haul and keep track of, as the securing device is attached to the ladder. The ladder locking device can also be used to secure other equipment along with the ladders by wrapping the cable around and securing the equipment with the lock provided on the ladder. The cable being used for the locking ladder is made of aircraft cable, which is virtually impossible to cut using bolt cutters or other conventional means. This invention will provide the contractor with the added security of knowing that they will not be in jeopardy of losing valuable equipment. This invention can also be used to secure equipment to vehicles, which eliminates the need for tie down straps that can become entangled or become loose. This will prevent unnecessary accidents from occurring when the equipment is being hauled from site to site. This device can be attached to any ladder or device that currently exists on the market. Once the equipment has been secured with the cable, the cable is wrapped around, returned to the device and locked into place. The device will remain in a secure and locked position until the contractor utilizes the key provided with the device. A master key can be made to provide the contractor with the ability to have multiple locking ladder devices and only maintain one key to open all of the devices. Another feature of the locking ladder device is that when the device is not in use, the cable is securely stored out of the way in the housing that is situated on the side of the ladder.

### SUMMARY OF INVENTION

The first aspect of the present invention is to offer a unique and never before attempted way of being able to secure equipment on a residential and/or commercial job site. This is achieved by allowing the contractor to lock the equipment to a structure using the locking ladder mechanism to wrap a cable around the equipment and secure the able to the mechanism, which would then require the use of a key to release the equipment at a future time.

Another aspect of the invention is the provision of the locking mechanism being connected directly to the ladders that are in use at the job site. The locking ladder mechanism, when not in use, is stored conveniently in the lock housing located on the side of the ladder. This will eliminate the need for additional inventory of chains and pad locks that are currently required to secure the equipment.

Yet a further aspect of the invention is that the cable that the locking ladder mechanism is designed with is aircraft cable, which can not be severed using conventional means. This would provde the contractor with the extra security that is required when leaving equipment on a job, site from day to day as the job progresses.

Still a further aspect of the invention is the provision of a locking ladder mechanism is inexpensive to manufacture, and easy to install and use, while being reliable and durable in operation.

A final aspect of the invention is that the locking ladder mechanism can be applied to both existing, as well as, new equipment.

To achieve these advantages and in accordance with the purposes of the invention, the invention includes a system comprising a 5/16″ aircraft cable, which is secured to a spring loaded pulley. This cable and pulley mechanism are secured within the metal housing by 1½″ bolts that attach to the ladder leg. This system is designed to allow the consumer to pull the aircraft cable from the metal housing and secure equipment by wrapping the cable around an immoveable object. Once the cable has been wrapped to the immoveable object, the cable is then inserted into the slot in the front of the metal housing and locked into place with a master key in the lock receptacle.

The locking ladder mechanism can be easily installed to existing, as well as, new residential and/or commercial ladders.

### SUMMARY OF INVENTION

The foregoing and other aspects of the invention which will become apparent as the detailed description proceeds, are achieved by the creation of a self contained mechanism that will provide the consumer the ability to secure equipment at a job site, or a vehicle, without the necessity of carrying around additional equipment that is conventional used. This system will also eliminate the need for other equipment to be secured separately from the ladders, as the cable can be interwoven with various equipment and locked in place in one location using a master key that will conveniently open the lock on the metal housing when the equipment is needed.

### BRIEF DESCRIPTION OF THE DRAWINGS

FIG. 1 is a side detail view of the locking ladder mechanism which includes the metal housing with cable and the lock housing.

FIG. 2 is a side view of the metal cable housing.

FIG. 3 is a side view of the lock mechanism housing.

FIG. 4 is a cross sectional plan view of the pulley within the metal housing and also the lock receptacle, elgonate are and the cable insertion slot on the lock housing.

FIG. 5 is a detailed operational view of the locking ladder mechanism

### DETAILED DESCRIPTION OF DRAWINGS

The following description of the preferred embodiments is meant for the purpose of illustration only and is in no way meant to limit the invention in spirit or scope as defined in the claims.

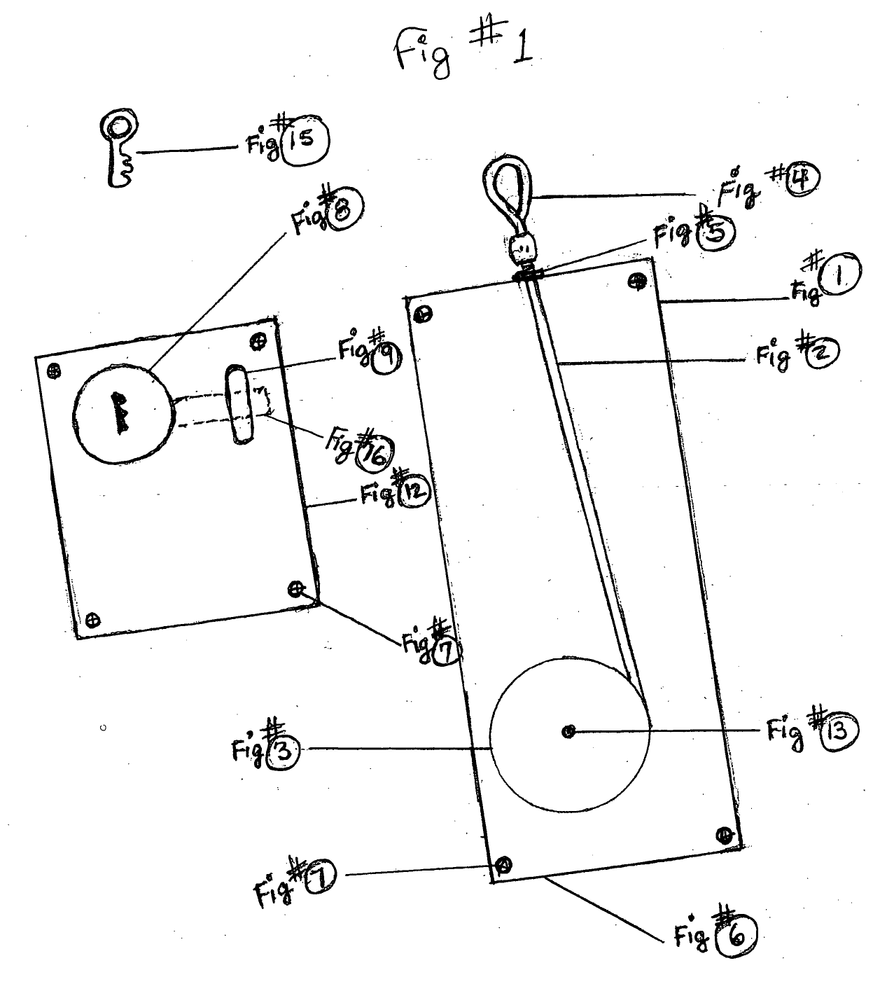

Referring to FIG. 1, two piece metal housing (2½″×6″×2″) #1 and #6 is constructed from mild stainless steel or aluminum, but is not limited to these materials, is cecured by four 1½″ bolts #7 that attach to the outside of the ladder frame. Within two piece metal housing #1 is a spring loaded 1½″ pulley #3. The spring loaded pulley #3 is attached to the metal housing #1 and #6 by means of a ⅜″×¾″ bolt #13. The 5/16″ aircraft cable #2 is attached to the spring loaded pulley #3. This allows for the extension and retraction of the aircraft cable when securing the ladder or other equipment. There is a 1″×⅜″ loop #4, which is attached to the top of the aircraft cable #2. This loop allows for the aircraft cable #2 to be inserted into the 1″×½″ slot #9 that is located on the lock housing which is then locked into place by the use of the elongate arm #16 and the lock receptacle #8. The threaded washer #5 with ½″ opening that is attached to the metal housing #1 is used to secure the loop #4 to the metal housing #1 when the locking ladder mechanism is not in use. #12 is the two piece metal locking housing (2½″×3″×2″). The lock housing #12 is secured to the outside of the opposite ladder frame by means of four bolts #7. On the top left of the lock housing #12 is the lock receptacle #8. A master key #15 will then be used with lock receptable #8 to raise and lower the elongate lock arm #16 when securing or releasing the ladders and/or other equipment.

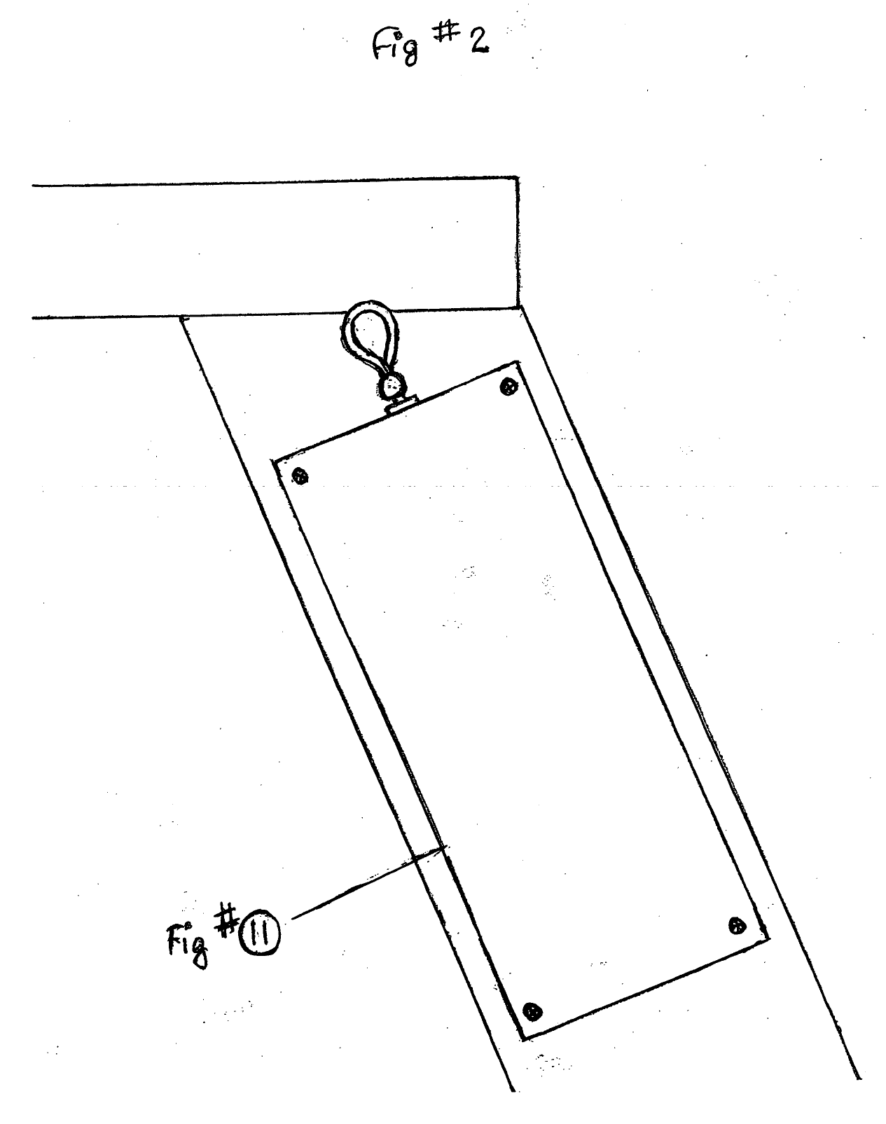

FIG. 2 is a side view of the metal cable housing as attached to the outside of the ladder frame #11.

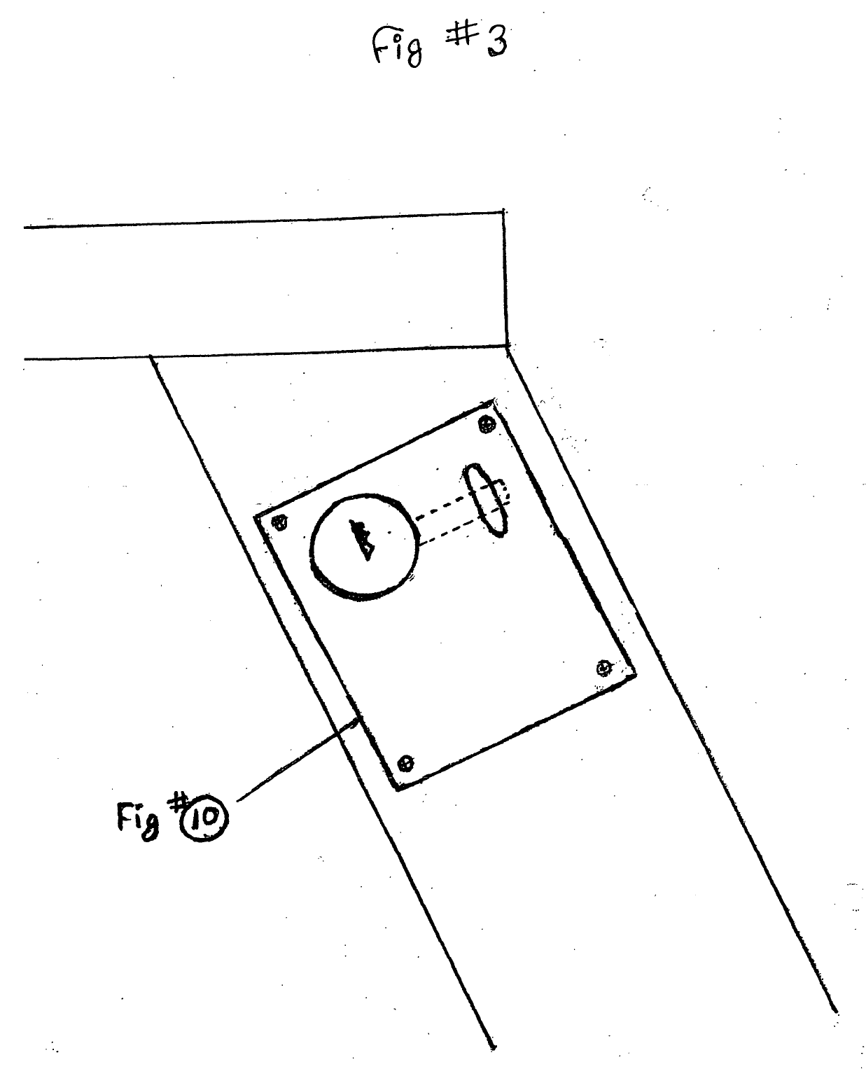

FIG. 3 is a side view of the lock housing as attached to the opposite side of the ladder frame #10.

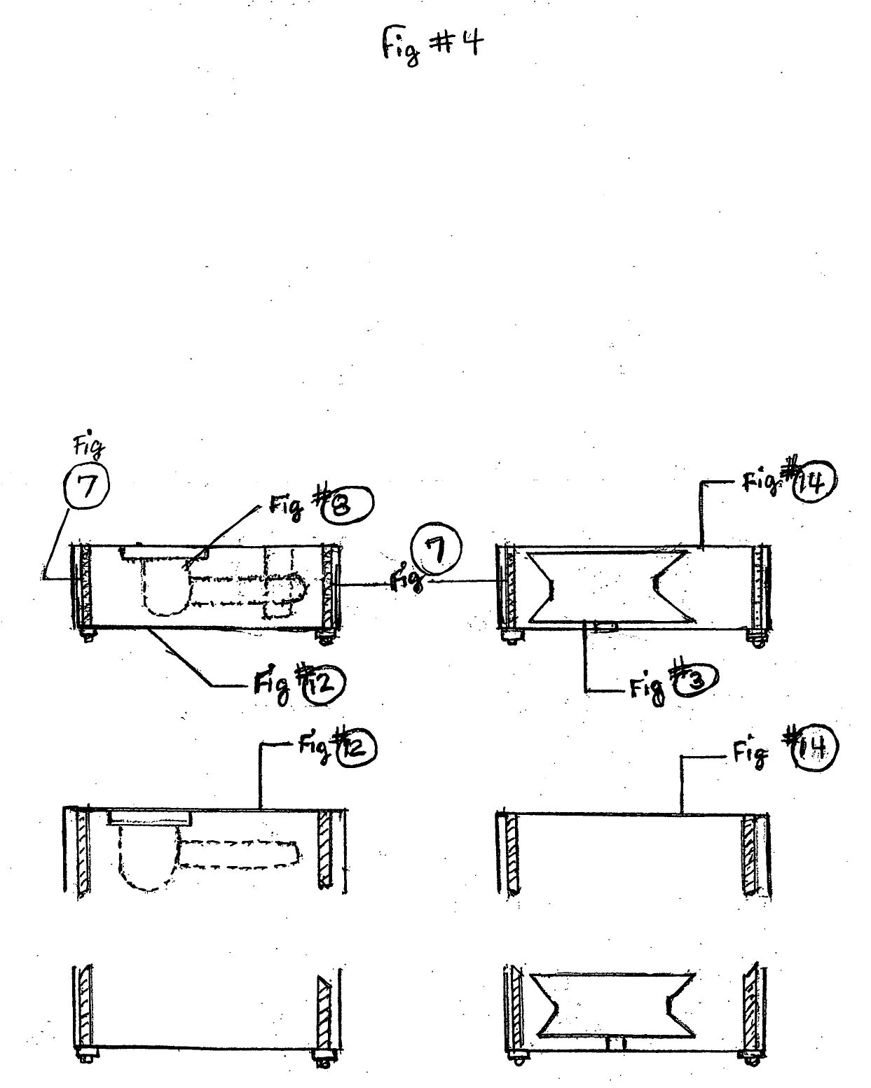

FIG. 4 is a cross sectional plan view of both the metal cable housing and the lock housing. The two piece (2½″×3″×2″) lock housing #12 is displayed on FIG. 4 in an open and in a secured position. The two piece lock housing #12 is held together by four bolts #7 that attach to the outside of the ladder frame. The detail of the elongate arm #8 is displayed in the locked position. The two piece (2½″×6″×2″) metal cable housing #14 is also displayed on FIG. 4 in both an open and in a secured position. The two piece metal cable housing #14 is the case for the spring-loaded pulley #3 and the aircraft cable that will secure the ladder and/or other equipment to the immoveable object as stated in the above claims. The two piece metal cable housing #14 is secured to the outside of the ladder frame by the useage of four bolts #7.

### DETAILED DESCRIPTION OF DRAWINGS

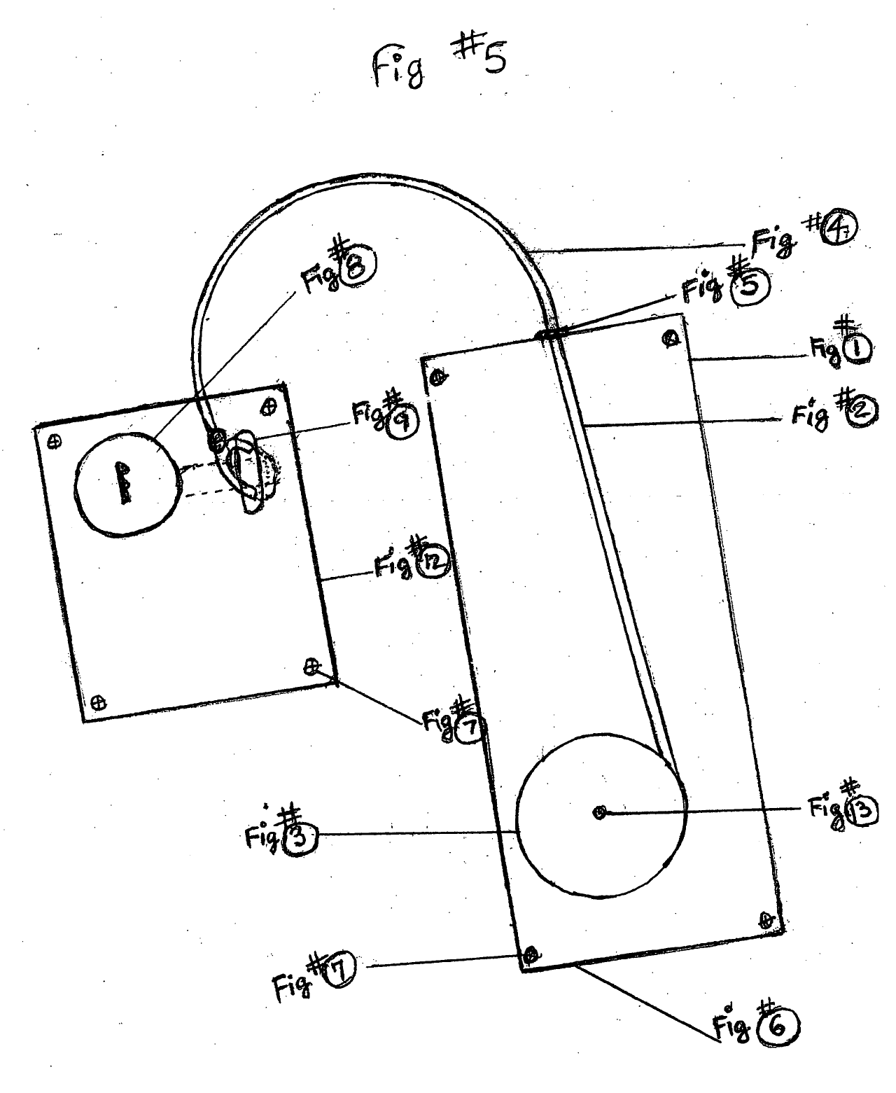

Referring to FIG. 5, this drawing is the same as FIG. 1 with the exception that this drawing displays the aircraft cable #2 being inserted into the slot #9. The two piece metal housing (2½″×6″×2″) #1 and #6 is constructed from mild stainless steel or aluminum, but is not limited to these materials, is cecured by four 1½″ bolts #7 that attach to the outside of the ladder frame. Within two piece metal housing #1 is a spring loaded 1½″ pulley #3. The spring loaded pulley #3 is attached to the metal housing #1 and #6 by means of a ⅜″×¾″ bolt #13. The 5/16″ aircraft cable #2 is attached to the spring loaded pulley #3. This allows for the extension and retraction of the aircraft cable when securing the ladder or other equipment. There is a 1″×⅜″ loop #4, which is attached to the top of the aircraft cable #2. This loop allows for the aircraft cable #2 to be inserted into the 1″×½″ slot #9 that is located on the lock housing which is then locked into place by the use of the elongate arm #16 and the lock receptacle #8. The threaded washer #5 with ½″ opening that is attached to the metal housing #1 is used to secure the loop #4 to the metal housing #1 when the locking ladder mechanism is not in use. #12 is the two piece metal locking housing (2½″×3″×2″). The lock housing #12 is secured to the outside of the opposite ladder frame by means of four bolts #7. On the top left of the lock housing #12 is the lock receptacle #8. A master key #15 will then be used with lock receptable #8 to raise and lower the elongate lock arm #16 when securing or releasing the ladders and/or other equipment.

The foregoing disclosure and description of the invention is illustrative and explanatory thereof, and various changes in the size, shape and materials, the use of mechanical equivalents, as well as in the details of the illustrated construction or combinations of features of the various elements may be made without departing from the spirit and intention of the invention.

What is claimed is:

1. A ladder lock for locking a ladder and/or other equipment to an immoveable object mounted entirely to said ladder comprising:
A metal housing securable to outside of one side of ladder frame;
A lock housing secured to outside of the opposite site of ladder frame, said lock housing supporting a guide and a receptacle for securing the aircraft cable from the metal housing;
An elongate lock arm slidably mounted within said lock housing to provide a sliding movement between a locked and unlocked position along an axis of said elongate lock and for rotation of said elongate lock arm about said axis;
One lock receptacle formed on said lock housing, said lock receptacle being operable for receiving a master key to thereby lock and unlock said ladder to and from said immoveable object.

2. The aircraft cable of claim 1, further comprising:
A loop at one end of said aircraft cable for insertion into lock housing receptacle.

3. The ladder lock of claim 2, wherein said loop is secured in place by a clamp and threaded washer on said aircraft cable.

4. The ladder lock of claim 1, further comprising:
A spring-loaded pulley within said metal housing, wherein the said aircraft cable is secured by use of a bolt attached to said spring-loaded pulley within said metal housing.

5. The ladder lock of claim 4, further comprising:
The said metal housing affixed to said ladder frame by the use of four bolts.

6. The ladder lock of claim 1, further comprises:
Said elongate lock arm comprises a lever that can be moved from an upper or lower position to open or close said lock receptacle and lock or release said aircraft cable.

7. The ladder lock of claim 6, further comprises:
A lock receptacle affixed with respect to said lock housing, said lock receptacle being operable for receiving a master key to thereby limit said sliding movement of said lock element and said elongate arm.

8. The ladder lock of claim 1, further comprising:
A two piece metal housing for containment of elongate are and lock receptacle.

9. The ladder lock of claim 8, further comprising:
Four bolts that will be utilized to attach said lock housing to ladder frame.
